(19) United States
(12) Patent Application Publication
(10) Pub. No.: US 2018/0322564 A1
(43) Pub. Date: Nov. 8, 2018

(54) System and Method for Accessing and Evaluating Orders in an Order Processing and Fulfillment System

(71) Applicant: DELL PRODUCTS, LP, Round Rock, TX (US)

(72) Inventors: Umesh Dheekonda, Secunderabad (IN); Mohammad Gouse, Telangana (IN); Devendar Polneni, Hyderabad (IN)

(21) Appl. No.: 15/584,829

(22) Filed: May 2, 2017

(51) Int. Cl. G06Q 30/06; G06Q 10/08

(52) U.S. Cl. CPC G06Q 30/0635; G06Q 10/087; G06Q 30/0641; G06Q 30/0603

(57) ABSTRACT

An order processing system includes a memory and a processor to instantiate an order fulfillment application to manage an order through a location in a workflow, and instantiate a rules engine. The rules engine receives the order and the location, selects a rule based upon the location, the rule including a condition field, a result, an operator, and an action, retrieves order information from the order fulfillment application for the order based upon the condition field, compares the order information with the result based upon the operator, evaluates the rule as being in a true state or a false state based upon a result of comparing the order information with the result, and provides response information to the order fulfillment application based upon the action when the rule is evaluated as being in the true state.

### FIELD OF THE DISCLOSURE

This disclosure generally relates to information handling systems, and more particularly relates to accessing and evaluating orders in an order processing and fulfillment system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An order processing system may include a memory and a processor to instantiate an order fulfillment application to manage an order through a location in a workflow, and instantiate a rules engine. The rules engine may receive the order and the location, select a rule based upon the location, the rule including a condition field, a result, an operator, and an action, retrieve order information from the order fulfillment application for the order based upon the condition field, compare the order information with the result based upon the operator, evaluate the rule as being in a true state or a false state based upon a result of comparing the order information with the result, and provide response information to the order fulfillment application based upon the action when the rule is evaluated as being in the true state.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an order processing and fulfillment system according to an embodiment of the present disclosure;

FIG. 2 illustrates a rule group according to an embodiment of the present disclosure;

FIG. 3 is a flowchart illustrating a method for accessing and evaluating orders in an order processing and fulfillment system according to an embodiment of the present disclosure; and

FIG. 4 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

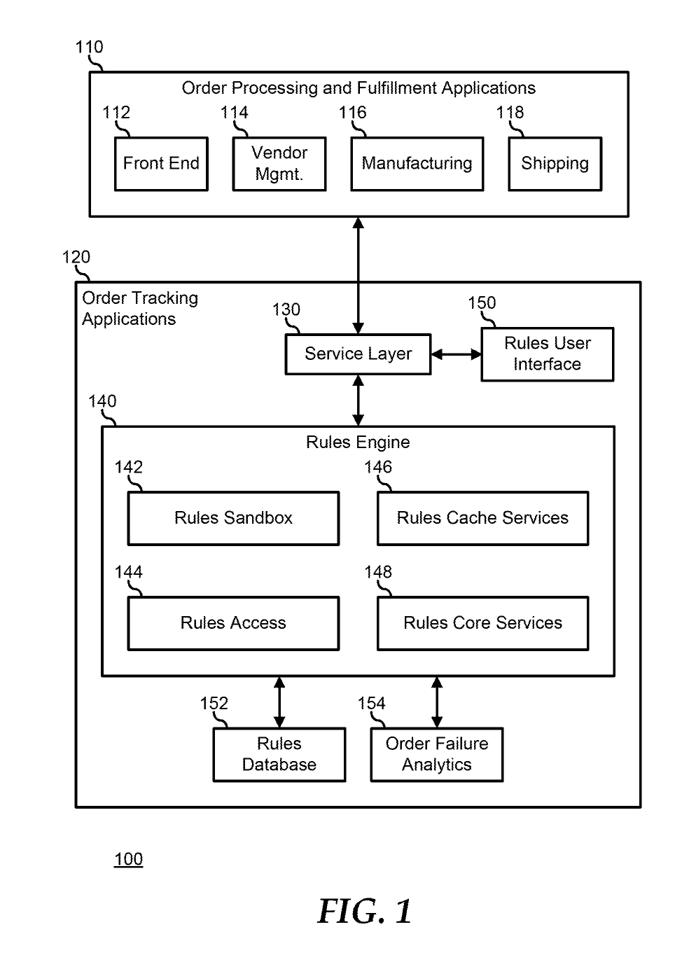

FIG. 1 illustrates an embodiment of an order processing and fulfillment (OPF) system 100. For purpose of this disclosure OPF system 100 can be represented by one or more information handling systems that can be configured to provide the features and to perform the functions of the OPF system as described herein. An information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

OPF system 100 includes various OPF applications 110 that together represent an end-to-end system for receiving, processing, tracking, and fulfilling orders for various products. In particular, OPF applications 110 include a front end application 112 that provides an interface for the creation of new orders, the tracking of existing orders, providing changes or cancellation of orders, or the like. As such, users, such as customers for the various products may interact with the front end application 112 via a user interface. Front end application 112 can include payment and billing systems, as needed or desired. OPF system 100 also includes a vendor management application 114 that provides for supply chain management and logistics for the creation of the desired products. OPF system 100 further includes a manufacturing application 116 that schedules and tracks the activities related to manufacturing, assembling, and building the desired products. OPF system 100 also includes a shipping application 118 to track the order fulfillment and shipping activities for the products. OPF applications 110 can include other applications, as needed or desired, such as service and maintenance applications, warranty and product return applications, knowledge bases, and the like, as needed or desired to provide an end-to-end order processing and management system. Finally, OPF system 100 includes order tracking applications 120, described further, below, that provide for order process troubleshooting and resolution Note that, as described herein, OPF system is focused on the types of functions and features that would be related to tangible products, but this is not necessarily so, and the functions and features of the OPF system can be readily adapted to other types of orders, including, but not limited to service products, information processing products, and the like.

OPF system 100 can be implemented by one or more information handling systems that operate together to provide the functions and features for processing orders through the OPF system. In a particular embodiment, OPF system 100 represents various applications that may be commercially available to provide one or more of the functions and features of the OPF system. In another embodiment, some or all of the functions and features of OPF system 100 are provided by an integrated order processing and fulfillment product. In either embodiment, the various functions and features of OPF system 100 provide information related to the location, status, timeliness, efficiency, or other performance measures for the orders that are processed on the OPF system. This information can be evaluated to detect trouble spots, failures, bottlenecks, slow-downs, or the like in OPF applications 110.

Even when OPF applications 110 is provided by an integrated order processing and fulfillment product, orders that experience problems at one or more stage of the processing may be difficult to identify, and even harder to trouble shoot to identify the root cause of the problems. As a first matter, a problem may not become readily apparent unless a service level agreement (SLA) is violated. For example, where a particular product is expected to ship within three days of receiving the order, a lack of a critical part in the supply chain, as indicated by a status within vendor management application 114, may inhibit the ability of manufacturing application 116 to make sufficient progress toward satisfying the SLA. However, it may not be automatic that the critical part inventory status is associated with the violation of the SLA, and the problem may not be identified and address until it is too late to satisfy the SLA.

In another case, a structural problems may exist with the functioning of OPF system 100, such that particular corner case orders may not be permitted to flow through the entire system, and such corner cases may not be readily understood until an example corner case order is processed. For example, a payment receipt and billing system of front end application 112 may provide a critical gateway to the initiation of manufacturing or shipment activities, and a case may arise where the payment was received, but an invalid shipping address was received that needs to be checked and corrected. Here, the payment receipt and billing system may be configured not to provide the order to manufacturing application 116 or to shipping application 118 until the shipping address conflict is resolved. However, it may be more desirable to have manufacturing application 116 and shipping application 118 gated off of payment confirmation, in order to let the shipping address conflict be resolved in parallel with the manufacturing and shipping activities. Under normal circumstances, this disconnect between the payment receipt and billing system and manufacturing application 116 and shipping application 118 may not be identified because shipping address problems are easily and routinely processed in sufficient time to ensure continued satisfaction of an SLA. However, a first time that the resolution of the shipping address conflict takes longer than the SLA may be the first time that the conflict is recognized or understood.

Moreover, problems may arise with orders within OPF applications 110 that are readily apparent, but the steps to resolve the problems may not be known. This may happen any time a new, or previously unrecognized problem occurs, and the resolution path may not be apparent from the nature of the problem. Further, even when the steps to resolve problems with orders within OPF system 100 are known, the steps may not be readily understood by the service groups tasked with resolving the problems. This may be a problem of providing access to the collected knowledge of the nature and resolution of problems experienced in the past, but that have not been communicated forward to new personnel who are charged with maintaining the various applications within OPF applications 110. Finally, obtaining the necessary information from OPF applications 110 to properly address problems, even when the problems are understood, may not be straight forward due to different dependencies within the OPF applications.

OPF system 100 includes order tracking applications 120 that provide for the tracking, managing, and maintenance of orders within OPF applications 110, and particularly provides order process troubleshooting and resolution in a way that addresses the problems cited above. Order tracking applications 120 includes a service layer 130, a rules engine 140, a rules user interface (UI) 150, a rules database 152, and an order failure analytics module 154. Broadly, order tracking applications 120 provides a rule-based mechanism for automatic or on-demand order tracking and troubleshooting. Users of order tracking applications 120 can include personnel associated with OPF system 100 that have broad need to access, evaluate, and troubleshoot the performance of the OPF system, personnel associated with the various applications of OPF applications 110 that have need to access, evaluate, and troubleshoot their respective applications, personnel associated with the order tracking applications that have need to create, manage, and maintain rules engine 140, to create, manage, and maintain the rules in rules database 152, and to create, maintain, and analyzed the rules via order failure analytics 154.

Rules engine 140 includes a rules sandbox 142, a rules access module 144, rules cache services 146, and rules core services 148. Rules sandbox 142 represents a controlled environment for creating, testing, and refining new rules before activating the new rules on OPF applications. Rules access module 144 provides an access layer between rules database 152 and the other elements of rules engine 120, through which the rules stored on the rules database are created, retrieved, modified, or deleted. Rules cache services 146 operate to retrieve, store, and utilize the rules from rules database 152 that are currently being utilized for the order intelligence activities of order tracking applications 120, as needed or desired. Rules core services 148 provides the core functionality of rules engine 140 to execute the appropriate rules over one or more orders which are provided as inputs upon which the rules are executed, to retrieve any information from OPF applications 110 that may be needed to execute the rules, and to administer the implementation of any actions on the applications of OPF applications 110, as may be called for by the rules. Service layer 130 sits atop rule engine 140 operating as a service endpoint, providing a web hosted environment for accessing the rule engine to perform the rules-based activities provided by the rules engine. Users associated with the various applications access order tracking applications 120 via rules user (UI) 150. As such, service layer 130 operates to exchange structured information for a web-based implementation of rules engine 130. An example of service layer 130 includes a service layer that operates on a Simple Object Access Protocol (SOAP), a REpresentational State Transfer (REST) mechanism, or the like.

Rules engine 140 receives one or more orders that are traversing OPF applications 110 and determines one or more rules that are run against the received orders to evaluate the status of the orders. In evaluating the status of an order, the rules operate to query OPF applications 110 to determine the location of the orders, to identify any critical paths associated with the current location, to determine any dependencies associated with the critical paths, to determine a likelihood that the dependencies will be satisfied in a timely manner, and to deliver a status report on the health of the order. If the dependencies are all on course to being satisfied for the order, the status report indicates that the order is on track for satisfying any associated SLAs. On the other hand, if the dependencies are not all on course to being satisfied for the order, the status report indicates that the order is not on track for satisfying the associated SLAs.

In either case, in a particular embodiment, rules engine 140 ascribes a likelihood that the order will continue to satisfy the associated SLAs as the order continues to traverse OPF applications 110 in the status report. For example, rules engine 140 can include a timetable associated with a hypothetical order. The timetable can indicate an ideal amount of time that should have elapsed since the hypothetical order was received for each location in OPF applications 110. The timetable can include time margins for each location that indicate an acceptable range of times that should have elapsed since the hypothetical order was received. Then, the rules can compare the actual amount of time that has elapsed since the order in question was received to the ideal amount of time for the order's location to determine the likelihood that the order will continue to satisfy the SLA. If the actual amount of time is on a low side of a time margin, then the rule can ascribe a higher likelihood that the order will continue to satisfy the associated SLAs, and if the actual amount of time is on a high side of a time margin, then the rule can ascribe a lower likelihood that the order will continue to satisfy the associated SLAs. In a further embodiment, rules engine 140 can maintain a dynamic timetable that takes into account current loading conditions in the various applications of OPF applications 110, and in the particular paths that the order is scheduled to take through the OPF applications. If the applications in the particular paths for the order are lightly loaded, then the rule can ascribe a higher likelihood that the order will continue to satisfy the associated SLAs, and if the applications in the particular paths for the order are heavily loaded, then the rule can ascribe a lower likelihood that the order will continue to satisfy the associated SLAs. Also, when the dependencies for the order are not all on course to being satisfied, the ascribed likelihood that the order will recover enough to meet the associated SLAs can be increased when the particular paths for the order are lightly loaded.

In another embodiment, if the dependencies associated with the critical path for a particular order are not all on course to being satisfied, the rules operate to take actions to correct the conditions that are not being satisfied. The actions can include providing commands or prompts to the applications of OPF applications 110 to address the unsatisfactory dependencies. For example, consider an order in manufacturing application 116 is going to need a part that shows insufficient inventory within the manufacturing facility, where the manufacturing application has provided a parts order to vendor management application 114 for a delivery of the needed part. Here, a rule, upon determining that the part delivery may not arrive to the manufacturing facility in a timely fashion to permit the order to satisfy the associated SLAs, can change a priority level for the parts order to expedite the delivery of the part. The actions that rules can take to correct a condition that is not being satisfied can also include communicating with support personnel associated with the application with the failing condition. For example, returning to the case where the address information is incorrect, the lack of action to correct the address information may gate the ability of shipping application 118 to ship the product associated with the order in conformance with the associated SLAs. Here, a rule can send a communication to support personnel associated with shipping application 118 to expedite the resolution of the shipping address issue. The communication can be provided by an e-mail, by an SMS text message, by a web interface for the associated application, or the like, as needed or desired.

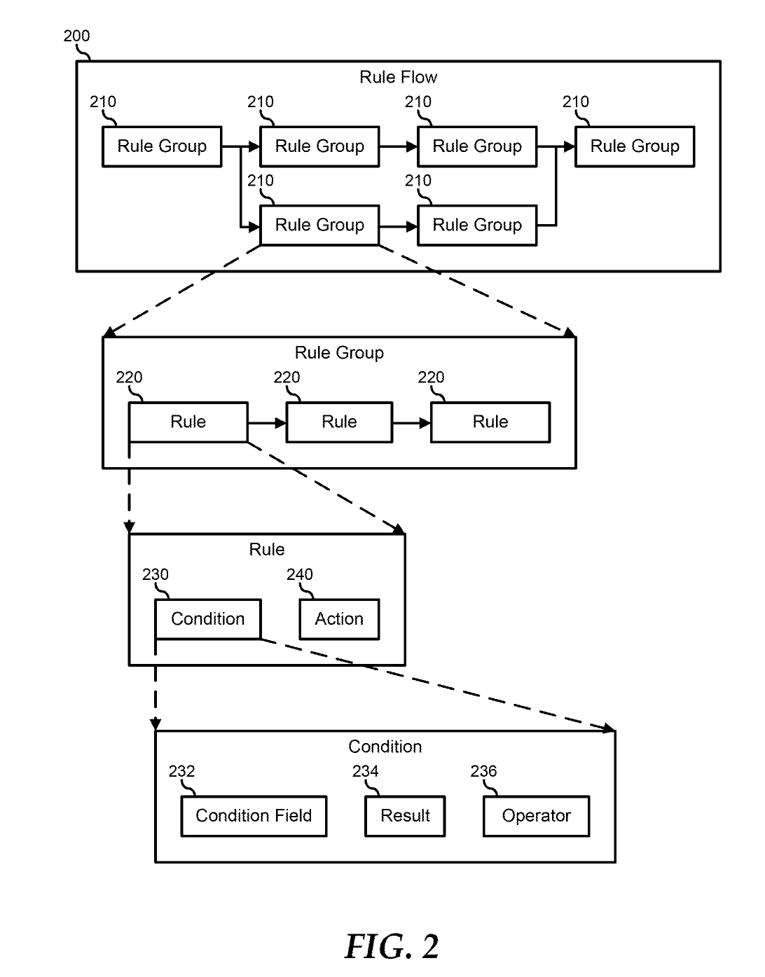

FIG. 2 illustrates a rule flow 200 associated with the path that orders will take in traversing OPF applications 110. Rule flow 200 represents an aggregation of all of the rules in rules database 152 in an ordered form that takes into account the various locations for orders in OPF applications 110. In a particular embodiment, a master rule flow is provided that depicts all known possible paths for an order, and all known dependencies as the order traverses OPF applications 110. In this embodiment, rule flow 200 represents a portion of the master rule flow that is associated with a particular location within OPF applications 110. Moreover, each particular location within OPF applications 110 will have an associated rule flow similar to rule flow 200. In a particular embodiment, rule flow 200 represents all portions of the master rule flow that occur at locations prior to the location associated with rule flow 200. For example, where rule flow 200 is associated with a final shipment check of a product on dock prior to transferring the product to a shipper, as handled by shipping application 118, then the rule flow can represent an execution of the bulk of the rules of the master rule flow, from rules associated with order entry in front end application 112, through rules associated with vendor management application 114 and manufacturing application 116, to the rules associated with the shipping application up to the transfer location. In another embodiment, rule flow 200 represents a truncated segment of the master rule flow that assumes that orders that have passed certain points were validly executed prior to those certain points. For example, in the final shipment check described above, rule flow 200 can represent an execution of the portion of the mater rule flow associated only with shipping application 118, based upon an assumption that, if the product was correctly manufactured, then the steps of OPF 110 prior to the shipping application have been validly executed in front end application 112, vendor management application 114, and manufacturing application 118.

Rule flow 200 includes one or more ordered rule groups 210. Each rule group 210 is associated with a particular location or activity within OPF applications 110. For example, continuing the shipping example from above, a first rule group can be related to receiving, in shipping application 118, a shipping order. After successful receipt of the shipping order, rule flow 200 can split into two paths. The first path can include a rule group associated with physically receiving the product and another rule group associated with packaging the product. The second path can include a first rule group associated with receiving the shipping address, and a second rule group associated with a final shipping address check. The two paths can merge with another rule group associated with printing and verifying a shipping label for the packaged product on the dock.

Rule group 210 includes one or more rules 220. Rules 220 represent knowledge-based encapsulations of the workings of the various locations of OPF applications 110, formalized into operations on orders in the OPF applications, and that rely on information from the OPF applications to determine the health and status of the particular orders against which the rules are executed. As such, rule 220 includes one or more conditions 230 and one or more actions 240 that are taken if the conditions are evaluated to a true state. Rule group 210 can be implemented as either a stop-first rule group or a stop-last rule group. In a stop-first rule group, when a particular rule evaluates to true and the associated action is taken, then the subsequent rules of the rule group are not executed. As such, a stop-first rule group embodies sufficient conditions to satisfy the intent of the rule group. For example, where rule group 210 represents the final shipping address check, a first rule can make an overall check of the shipping address. If the shipping address is checked by the rule and found to be a valid shipping address, there may be no further need to execute subsequent rules in the rule group. In a stop-last rule group, all of the rules that are evaluated to true have their associated actions taken. As such, all rules in a stop-last rule group will be executed. As such, a stop-last rule group embodies necessary conditions to satisfy the intent of the rule group. For example, where rule group 210 represents the packaging of the product, a first rule can check an inventory status of packing materials, such as inserts and shipping boxes, a second rule can check for the availability of collateral material, such as warranty information or a user's manual, and a third rule can check the final packaging of the product with the packing materials and the collateral. Here, all three rules have to be evaluated to true to correctly ascertain whether or not the product was properly packaged.

Rule 220 includes a condition 230 and an action 240. Condition 230 includes a condition field 232, a result 234, and an operator 236. Condition field 232 represents a particular object, such as a database object or a XPATH in an XML document, that is obtained from an element of OPF applications 110. In particular, condition field 232 represents a particular location, or information related to the location. Condition field 232 can include a specific element in an XML document or a stored procedure or function in a database. The information returned can include an alpha-numeric value, a string value, a regular expression, another type of database or XML information, or the like, as needed or desired. Result 234 represents information against which the information from condition field 232 is evaluated with operator 238 to determine a result of rule 220. As such, for any given rule 220, result 234 will represent a same type of value as that described by condition field 232. Operator 236 represents an instruction of rule 220 as to what sort of evaluation is to be performed between the information of condition field 232 and the information of result 234. An example of operator 236 includes mathematical operators such as = (equal to), < > (not equal to), > (greater than), >= (greater than or equal to), < (less than), or <= (less than or equal to), or other mathematical operators. Further, operator 236 can include list operators such as Contains, Contains All, Not Contains, Not Contains All, or other list operators. Operator 236 can also include string matching operators on regular expressions. Action 240 represents the steps to be taken by rule 220 when condition 230 evaluates to a true state. Action 240 can include an action event, such as prompting a mechanism of one or more of OPF applications 110 to correct a problem with an order or to invoke a failure mechanism, providing a communication to personnel associated with a particular location as to actions needed to heal a particular order, invoking a workflow, either within rules engine 140 or within the OPF applications to address the condition that evaluated to true. Action 240 can also include a value that is to be passed to one or more elements of OPF 110 to enable the performance of a particular task. Rule 220 can be implemented as either a stop-first rule or a stop-last rule. In a stop-first rule group, when a particular condition evaluates to true, then the subsequent conditions of the rule are not executed. As such, the action or actions are taken upon the event of the first condition being evaluated as true. In a stop-last rule, all of the conditions of the rule have to be evaluated as true before the actions are taken.

Returning to FIG. 1, rules engine 140 operates in one of three different modes. In an on-demand or static mode a user accesses rules engine 140 via rules UI 150 and provides the rules engine with a particular order that is traversing OPF applications 110. Rules engine 140 determines a rule flow similar to rule flow 200 and executes the rules flow against the order to determine a current status for the order, and to take any indicated actions on behalf of the order as provided by the various rules associated with the rules flow. As an option, the user can specify to run all rules of the master rule flow against the order to get an overview of the progress of the order thorough OPF applications 110. In an order-targeted or dynamic mode, one or more orders are selected, and the associated rules flows for the orders are executed at various times through the order process. For example, where a SLA provides a one week throughput through OPF applications 110, one or more orders can be selected when the orders are received. Then at a pre-determined time interval, such as every 12 hours or every 24 hours, the locations associated with the orders can be determined and the rules flows for the locations are executed against the orders. In this way, a routine health status for OPF applications can be maintained. In a location-targeted mode, a particular location within OPF applications 110 is selected, such as a location that is known to be a bottleneck for the order process or a location that has had periodic problems. Then all orders that are processed to the particular location are evaluated by the rule flow associated with that location. In this way, the health of the bottleneck of the problematic location can be monitored.

In a particular embodiment, rules, such as rule 220, are created based upon the experience and knowledge of the personnel associated with OPF system 100. For example, when new or previously unknown issues are identified, the process of determining a root cause and the appropriate response actions may be determined by the personnel associated with the particular application of OPF applications 110 that experienced the issues. Here, after a root cause of an issue is determined and the appropriate response actions identified, a rule can be created to capture the conditions that led to the issue and to provide as actions for the rule the identified actions. Then, the newly created rule is added to rules database 152, and is linked in to an associated rules group, similar to rules group 210. Further, if the issue results in several rules being created that are associated together in a new rule group, the rule group is appended to the master rule flow, and is included in the rules flows associated with the location within OPF applications that had the issue.

In a particular embodiment, order failure analytics 156 operates to track the invocation of the rules in rules database 152 by rules engine 150 and the disposition of the execution of the rules. Then, order failure analytics 156 performs various analytical methods to identify potential problems in OPF applications 110. For example, order failure analytics 156 can sum up the number of times a particular rule is invoked and is resolved to the true state. Then, order failure analytics 156 can implement a failure threshold such that, when a particular rule is invoked and resolved to the true state more times than indicated by the failure threshold, then the order failure analytics can flag the rule such that personnel associated with the rule failure can work to improve the performance of the element of OPF applications that is associated with the rule failure.

FIG. 3 illustrates a method for accessing and evaluating orders in an order processing and fulfillment system. A rules engine of an OPF system is invoked to run a rule for a particular order at a particular location in OPF applications in block 302. For example, a user of OPF system 100 can invoke rule engine 130 to evaluate an order that is at a particular location within an OPF application of the OPF system in an on-demand mode operation, the rules engine can be set to periodically evaluate one or more orders in an order-based mode operation, or the rules engine can be set to evaluate all orders that arrive at a particular location in a location-based mode operation. Based upon the location of the order received in block 302, the rules engine determines a rule flow associated with the particular location in block 304.

A first rule group of the rule flow is selected in block 306, and a first rule of the rule group is selected in block 308. The rules engine evaluates the order based on a first condition of the rule in block 310, and a decision is made as to whether or not the first condition evaluates to a true state in decision block 312. If not, the “NO” branch of decision block 312 is taken and a decision is made as to whether or not the condition evaluated in block 310 is a last condition of the rule in decision block 320. If not, the “NO” branch of decision block 320 is taken, the actions of the rule are performed in block 321, and the method returns to block 310 where the rules engine evaluates the order based on a next condition of the rule. If the condition evaluated in block 310 is the last condition of the rule, the “YES” branch of decision block 320 is taken and the method proceeds to block 316, as described below. Returning to decision block 312, if the first condition evaluates to the true state, the “YES” branch of the decision block is taken, and a decision is made as to whether or not the rule is designated as a stop-first rule in decision block 314. If not, the “NO” branch of decision block 314 is taken, the method proceeds to decision block 320 where a decision is made as to whether or not the condition evaluated in block 310 is the last condition of the rule, and the method proceeds as described above. If the rule is designated as a stop-first rule, the “YES” branch of decision block 314 is taken and the method proceeds to block 316, as described below.

If either of the “YES” branches of decision blocks 314 and 320 are taken, as described above, or the “NO” branch of decision block 318 is taken, as described below, the method proceeds to block 316, where a first action of the rule is performed. A decision is made as to whether or not the action taken in block 316 is the last action of the rule in decision block 318. If not, the method returns to block 316 where the next action of the rule is performed. If the action taken in block 316 is the last action of the rule, the “YES” branch of decision block 318 and a decision is made as to whether or not any of the conditions of the selected rule were evaluated to the true state in decision block 322. If not, the “NO” branch of decision block 322 is taken and the method proceeds to decision block 324 as described below. If any of the conditions of the selected rule were evaluated to the true state, the “YES” branch of decision block 322 is taken and a decision is made as to whether or not the selected group is a stop-first rule in decision block 326. If not, the “NO” branch of decision block 326 is taken and the method proceeds to decision block 324 as described below.

If either of the “NO” branches of decision blocks 322 and 326 are taken, a decision is made as to whether or not the selected rule is the last rule of the selected rule group in decision block 324. If not, the “NO” branch of decision block 324 is taken and the method returns to block 308 where a next rule of the rule group is selected. If the selected rule is the last rule of the selected rule group, the “YES” branch of decision block 324 is taken and the method proceeds to decision block 328. If either of the “YES” branches of decision blocks 324 and 326 are taken, a decision is made as to whether or not the selected rule group is the last rule group of the rule flow in decision block 328. If not, the “NO” branch of decision block 328 is taken and the method returns to block 304 where a next rule group of the rule flow is selected. If the selected rule is the last rule of the rule group in, the “YES” branch of decision block 328 is taken and the method ends at block 330.

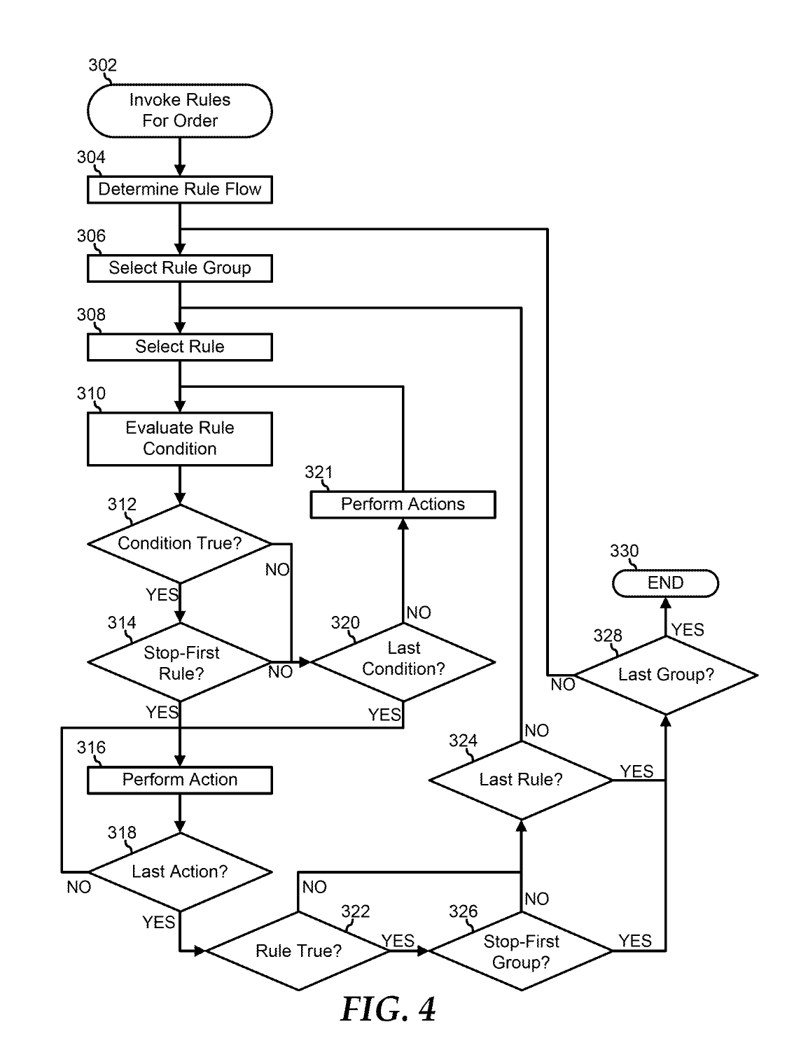

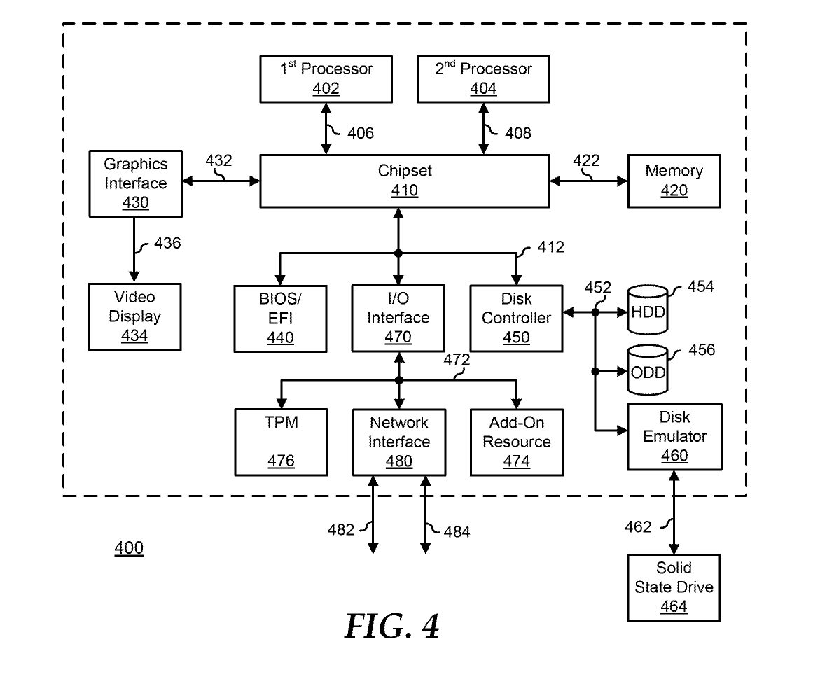

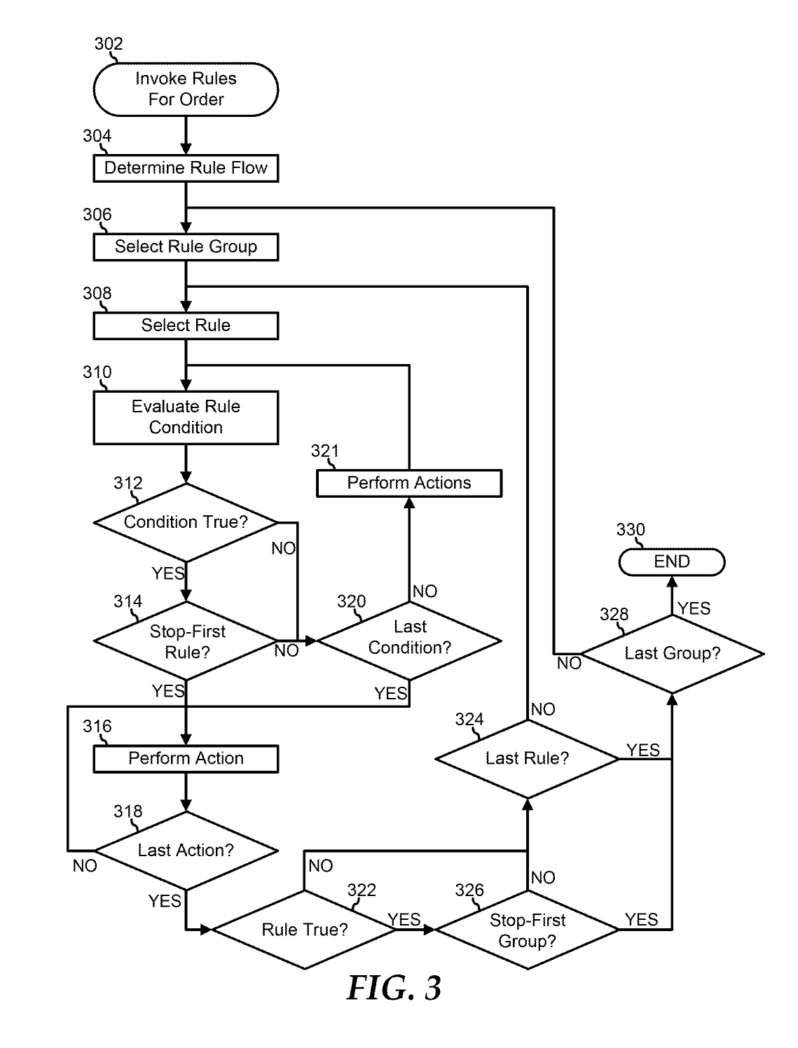

FIG. 4 illustrates a generalized embodiment of information handling system 400. For purpose of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described above, and operates to perform one or more of the methods described above. Information handling system 400 includes a processors 402 and 404, a chipset 410, a memory 420, a graphics interface 430, include a basic input and output system/extensible firmware interface (BIOS/EFI) module 440, a disk controller 450, a disk emulator 460, an input/output (I/O) interface 470, and a network interface 480. Processor 402 is connected to chipset 410 via processor interface 406, and processor 404 is connected to the chipset via processor interface 408. Memory 420 is connected to chipset 410 via a memory bus 422. Graphics interface 430 is connected to chipset 410 via a graphics interface 432, and provides a video display output 436 to a video display 434. In a particular embodiment, information handling system 400 includes separate memories that are dedicated to each of processors 402 and 404 via separate memory interfaces. An example of memory 420 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 440, disk controller 450, and I/O interface 470 are connected to chipset 410 via an I/O channel 412. An example of I/O channel 412 includes a Peripheral Component Interconnect (PCI) interface, a PCI-Extended (PCI-X) interface, a high speed PCI-Express (PCIe) interface, another industry standard or proprietary communication interface, or a combination thereof. Chipset 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 440 includes BIOS/EFI code operable to detect resources within information handling system 400, to provide drivers for the resources, initialize the resources, and access the resources. BIOS/EFI module 440 includes code that operates to detect resources within information handling system 400, to provide drivers for the resources, to initialize the resources, and to access the resources.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits a solid-state drive 464 to be connected to information handling system 400 via an external interface 462. An example of external interface 462 includes a USB interface, an IEEE 1394 (Firewire) interface, a proprietary interface, or a combination thereof. Alternatively, solid-state drive 464 can be disposed within information handling system 400.

I/O interface 470 includes a peripheral interface 472 that connects the I/O interface to an add-on resource 474, to a TPM 476, and to network interface 480. Peripheral interface 472 can be the same type of interface as I/O channel 412, or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as chipset 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An order processing system, comprising:
a memory including machine readable code; and
a processor to execute the machine readable code to:
instantiate an order fulfillment application to manage an order through a location in a workflow; and
instantiate a rules engine to:
receive the order and the location;
select a rule based upon the location, the rule including a condition field, a result, an operator, and an action;
retrieve order information from the order fulfillment application for the order based upon the condition field;
compare the order information with the result based upon the operator;
evaluate the rule as being in a true state or a false state based upon a result of comparing the order information with the result; and
provide response information to the order fulfillment application based upon the action when the rule is evaluated as being in the true state.

2. The order processing system of claim 1, wherein the processor further instantiates the order fulfillment application to:
receive the response information; and
apply the response information to the order.

3. The order processing system of claim 2, wherein, in applying the response information to the order, the processor further instantiates the order fulfillment application to:
correct a condition of the order fulfillment application, wherein the condition prevents the order from proceeding past the location.

4. The order processing system of claim 2, wherein, in applying the response information to the order, the processor further instantiates the order fulfillment application to:
provide directions to correct a condition of the order fulfillment application, wherein the condition prevents the order from proceeding past the location.

5. The order processing system of claim 1, wherein the response information includes an indication of a performance of the order to a service level agreement (SLA).

6. The order processing system of claim 5, wherein the performance of the order to the SLA, comprises a percent likelihood that the order will satisfy the SLA

7. The order processing system of claim 1, wherein the processor further instantiates the rules engine to receive the order and the location in a request from the order fulfillment application.

8. The order processing system of claim 1, wherein the processor further instantiates the rules engine to receive the order and the location in response to a periodic request to the order fulfillment application from the rules engine.

9. An method, comprising:
instantiating, by a processor of an order processing system, an order fulfillment application;
managing, by the order fulfillment application, an order through a location in a workflow of the order processing system;
instantiating, by the processor, a rules engine;
receiving, by the rules engine, the order and the location;
selecting, by the rules engine, a rule based upon the location, the rule including a condition field, a result, an operator, and an action;
retrieving, from the order fulfillment application, order information for the order based upon the condition field;
comparing, by the rules engine, the order information with the result based upon the operator;
evaluating, by the rules engine, the rule as being in a true state or a false state based upon a result of comparing the order information with the result; and
providing, by the rules engine, response information to the order fulfillment application based upon the action when the rule is evaluated as being in the true state.

10. The method of claim 9, further comprising:
receiving, by the order fulfillment application, the response information; and
applying, by the order fulfillment application, the response information to the order.

11. The method of claim 10, wherein, in applying the response information to the order, the method further comprises:
correcting, by the order fulfillment application, a condition of the order fulfillment application, wherein the condition prevents the order from proceeding past the location.

12. The method of claim 10, wherein, in applying the response information to the order, the method further comprises:
providing directions to correct a condition of the order fulfillment application, wherein the condition prevents the order from proceeding past the location.

13. The method of claim 9, wherein the response information includes an indication of a performance of the order to a service level agreement (SLA).

14. The method of claim 13, wherein the performance of the order to the SLA, comprises a percent likelihood that the order will satisfy the SLA

15. The method of claim 9, wherein receiving the order and the location is in response to a request from the order fulfillment application.

16. The method of claim 9, wherein receiving the order and the location is in response to a periodic request to the order fulfillment application from the rules engine.

17. An order processing system, comprising:
a memory including machine readable code; and
a processor to execute the machine readable code to instantiate a rules engine to:
receive an order and a location of the order in a workflow of an order fulfillment system;
select a rule based upon the location, the rule including a condition field, a result, an operator, and an action;
retrieve order information associated with the order based upon the condition field;
compare the order information with the result based upon the operator;
evaluate the rule as being in a true state or a false state based upon a result of comparing the order information with the result; and
provide response information based upon the action when the rule is evaluated as being in the true state.

18. The order processing system of claim 17, wherein the processor further instantiates the rules engine to:
apply the response information to the order.

19. The order processing system of claim 18, wherein, in applying the response information to the order, the processor further instantiates the rules engine to:
correct a condition of the order, wherein the condition prevents the order from proceeding past the location.

20. The order processing system of claim 18, wherein, in applying the response information to the order, the processor further instantiates the rules engine to:
provide directions to correct a condition of the order, wherein the condition prevents the order from proceeding past the location.
